(19) United States
(12) Patent Application Publication
(10) Pub. No.: US 2013/0140874 A1
(43) Pub. Date: Jun. 6, 2013

(54) WHEEL FOR AUTOMOBILE

(71) Applicant: Noriyuki Fukaya, Aichi (JP)

(72) Inventor: Noriyuki Fukaya, Aichi (JP)

(73) Assignee: CENTRAL MOTOR WHEEL CO., LTD., Anjo-shi, Aichi (JP)

(21) Appl. No.: 13/817,824

(22) PCT Filed: Jul. 28, 2011
(86) PCT No.: PCT/JP2011/067218

§ 371 Date: Feb. 19, 2013

(30) Foreign Application Priority Data
Sep. 24, 2010 (JP) 2010-212989

(51) Int. Cl. B60B 3/00

(52) U.S. Cl. CPC B60B 3/005
USPC 301/5.21; 301/63.103

(57) ABSTRACT

A wheel for an automobile is configured in such a manner that the wheel disc comprises an outer peripheral ring section having protrusions and recesses, the outer peripheral ring section being formed by continuously and alternately forming circular arc-shaped contact sections and contactless protrusion sections along the circumferential direction of the wheel, the circular arc-shaped contact sections being in contact with and welded to the bent peripheral section of the wheel rim, the contactless protrusion sections protruding further toward the front side than the circular arc-shaped contact sections and separating from the bent peripheral section. Welded sections at which the circular arc-shaped contact sections and the bent peripheral sections are welded together are intermittently arranged in the circumferential direction of the wheel. The configuration provides a large design surface to improve the freedom of design and improves the rigidity because of the shape effect of the outer peripheral ring section having protrusions and recesses.

### FIELD OF THE INVENTION

The present invention relates to an automotive wheel in which a wheel rim on which a tire is to be mounted and a wheel disc to which an axle is to be coupled are welded to each other for integration.

### BACKGROUND ART

There are so-called two-piece automotive wheels in which a generally cylindrical wheel rim and a generally disc-like wheel disc are welded to each other. As such two-piece automotive wheels, there are well-known well-fitting type wheels in which the wheel disc is fitted inside and welded to a well portion of the wheel rim and bead-fitting type wheels in which the wheel disc is fitted inside and welded to a front bead seat portion of the wheel rim. In addition, there are also known, as shown in FIG. 7, full-face type automotive wheels “h” in which a front flange portion “n” for supporting a front bead of the tire is formed at an outer peripheral edge of the wheel disc “m”. The full-face type automotive wheel “h” has a structure such that the wheel rim “i” is formed with the front bead seat portion “j” at one opening periphery and a back rim flange portion “k” at the other opening periphery, and one opening periphery (an opening edge of the front bead seat portion “j”) is brought into contact with and welded to a back surface of the wheel disc “m”. Such full-dace type automotive wheel “h” has the advantage in its capability to secure a larger design surface on the wheel disc “m” than the aforementioned well-fitting type or bead-fitting type wheels.

Alternative automotive wheel is also proposed in JP-A-Hei 9-2003, for example such that an outer peripheral end of the wheel disc is fitted inside and welded to the front rim flange portion of the wheel rim. In this case, the larger design surface on the wheel disc can be advantageously secured than the aforementioned bead-fitting type or well-fitting type wheels.

### DISCLOSURE OF THE INVENTION

### Problem to be Solved by the Invention

The automotive wheel is desired to be constructed to provide higher stiffness so as to improve the effect of control stability, weight reduction, or the like. Specifically, it is highly desired that the automotive wheel can secure the large design surface as the full-face type wheels or the structure proposed in JP-A-Hei 9-2003 and also provide the improvement effect of the stiffness.

The present invention proposes an automotive wheel that can secure a large design surface and also exhibit high stiffness.

### SUMMARY OF THE INVENTION

The present invention is an automotive wheel provided with a wheel rim including bead seat portions for supporting beads of a tire and rim flange portions continuously formed from the bead seat portions and bending to radial outsides, each of which is provided on a front and a back sides, and a wheel disc, and which the wheel disc and the wheel rim are welded together, in which the wheel disc includes: an outer peripheral concavoconvex annular portion in which a plurality of arc-shaped abutting portions abutting on bending peripheral portions continuously formed from front bead seat portions to front rim flange portions of the wheel rim and formed intermittently along a circumference of the wheel, are formed along the circumference of the wheel continuously with a plurality of non-abutting convex portions formed to protrude toward the front side with respect to the arc-shaped abutting portions, spaced from the bending peripheral portion, and provided between adjacent arc-shaped abutting portions; and an outer peripheral fitting end provided in a radial outside of the outer peripheral concavoconvex annular portion and fitted with an outer peripheral end of the front rim flange portion of the wheel rim, and in which welding portions where the bending peripheral portions of the wheel rim are respectively welded to the arc-shaped abutting portions of the wheel disc, are formed intermittently along the circumference of the wheel.

According to such a structure, the stiffness of the wheel disc in the circumferential direction and in the front and the back side directions of the wheel can be improved by the shape effect of the outer peripheral concavoconvex annular portion in which arc-shaped abutting portions are alternately formed with non-abutting convex portions in the circumferential direction of the wheel. Consequently, the automotive wheel according to the present invention can sufficiently provide the desired stiffness.

In this structure, the rim flange portion of the wheel rim is fitted with the outer peripheral fitting end formed in the radial outside of the outer peripheral concavoconvex annular portion, and the design surface on the wheel disc can be secured as large as that of the full-face type wheel described above. Therefore, the effect of high degree of freedom in design can be provided. Thus, the structure of the present invention can provide the effect of the high degree of freedom in design and also the effect of improving the stiffness described above.

In this structure, the rim flange portion of the wheel rim is fitted with the outer peripheral fitting end formed in the radial outside of the outer peripheral concavoconvex annular portion, and thus the center axes of the wheel rim and the wheel disc can be aligned easily. That is, in a process in which the wheel rim and the wheel disc are joined during manufacturing processes, the wheel rim and the wheel disc can easily and stably be positioned so that the respective center axes are aligned. Therefore, the present invention has an advantage that production time and cost can be reduced.

In the automotive wheel according to the present invention discussed above, it is proposed that the wheel disc includes: a hub mounting portion coupled to an axle; a plurality of spokes extending radially from the hub mounting portion toward the radial outside; and a plurality of ornamental holes provided between adjacent spokes, the arc-shaped abutting portion is formed by a hole outer edge portion provided in the radial outside of each ornament hole, and the non-abutting convex portion is formed by an outer end of each spoke.

According to such a structure, the outer peripheral concavoconvex annular portion with concave and convex portions lying in the front and the back side direction can be formed according to the shape of the spoke and the ornamental hole alternately formed along the circumference of the wheel. Consequently, the effect of high degree of freedom in design and the effect of improving the stiffness can be provided.

In the automotive wheel according to the present invention discussed above, it is proposed that the outer peripheral fitting end of the wheel disc includes a stepped peripheral fitting portion circumferentially formed to be cut from the back side of an outermost peripheral end of the wheel disc to the radial outside, and the stepped peripheral fitting portion is fitted with the outer peripheral end of the front rim flange portion of the wheel rim.

According to such a structure, the stepped peripheral fitting portion which is fitted with the outer peripheral end of the front rim flange portion of the wheel rim, is formed in the outermost peripheral end of the wheel disc, and thus large design surface can be secured quite effectively. Therefore, the present invention further excels in providing an operational advantage of the high degree of freedom in design described above.

Furthermore, the boundary between the outer peripheral fitting end of the wheel disc and the outer peripheral end of the front rim flange portion of the wheel rim is hardly visible from the front side. Thus, the contamination produced by rust which often appears on the boundary can be obscured in this structure in comparison with the structure in which the boundary is exposed to the design surface. In this structure, it is preferable that the boundary be not exposed to the front side.

In the automotive wheel according to the present invention discussed above, it is proposed that a weight capable of adjusting wheel weight balance is disposed at a specified position in an annular gap formed between the outer peripheral concavoconvex annular portion of the wheel disc and the front rim flange portion of the wheel rim and over the circumference of the wheel.

According to such a structure, the weight that can adjust the balance of the wheel weight can be disposed without any influence on a clearance relative to a brake and the like or the degree of freedom in design. Specifically, in a case where a relatively large weight is attached in order to correct an imbalance due to the attaching of an air valve with a pneumatic sensor, the present invention can preferably be used.

### Effect of the Invention

An automotive wheel according to the present invention is constructed as discussed above such that the wheel disc includes; the outer peripheral concavoconvex annular portion in which a plurality of arc-shaped abutting portions abutting on and welded with bending peripheral portions of the wheel rim are alternately and continuously formed along the circumference of the wheel with a plurality of non-abutting convex portions protruding toward the front side with respect to the arc-shaped abutting portions and spaced from the bending peripheral portion; and the outer peripheral fitting end fitted with the outer peripheral end of the rim flange portion of the wheel rim. Therefore, the high stiffness can be provided by the shape effect of the outer peripheral concavoconvex annular portion. Furthermore, because a large design surface can be secured on the wheel disc, the degree of freedom in design can be improved. Thus, according to the structure of the present invention, the degree of freedom in design can be improved, while the stiffness can be improved.

In the automotive wheel discussed above, when the wheel disc includes a plurality of the spokes and a plurality of the ornamental holes, the non-abutting convex portion is formed by the outer end of each spoke, and the arc-shaped abutting portion is formed by the hole outer edge portion of each ornament hole, the outer peripheral concavoconvex annular portion can be formed according to the concave and the convex shapes of the spoke and the ornamental hole, and therefore the effect of the present invention discussed above can be achieved appropriately.

In the automotive wheel discussed above, when the outer peripheral fitting end of the wheel disc is formed by the stepped peripheral fitting portion cut in the outermost peripheral end of the wheel disc, the present invention has an excellent effect of improving the degree of freedom in design. Furthermore, since the boundary between the outer peripheral fitting end and the outer peripheral end of the front rim flange portion of the wheel rim is hardly visible from the front side, the effect such that the contamination produced on the boundary by rust is obscured can be achieved.

In the automotive wheel of the present invention discussed above, when the weight capable of adjusting wheel weight balance is disposed at the specified position in the annular gap formed between the outer peripheral concavoconvex annular portion of the wheel disc and the front rim flange portion of the wheel rim, the weight can be disposed without any influence on the clearance relative to the brake and the like or the degree of freedom in design.

### BRIEF DESCRIPTION OF THE DRAWINGS

FIG. 1 is a plan view of an automotive wheel 1 according to an embodiment.

FIG. 2 is a cross-sectional view taken along the line P-P of FIG. 1.

FIG. 3 is an enlarged view of a section X in FIG. 2.

FIG. 4 is an enlarged view of a section Y in FIG. 2.

FIG. 5 is an exploded cross-sectional view of a wheel rim 2 and a wheel disc 3.

FIG. 6A is an enlarged vertical sectional view of a formation section for a valve hole 8, and FIG. 6B is an enlarged vertical sectional view of an opposite section facing the valve hole 8, of the automotive wheel 1 according to the embodiment.

FIG. 7 is an enlarged cross-sectional view of a conventional full-face type automotive wheel “h”.

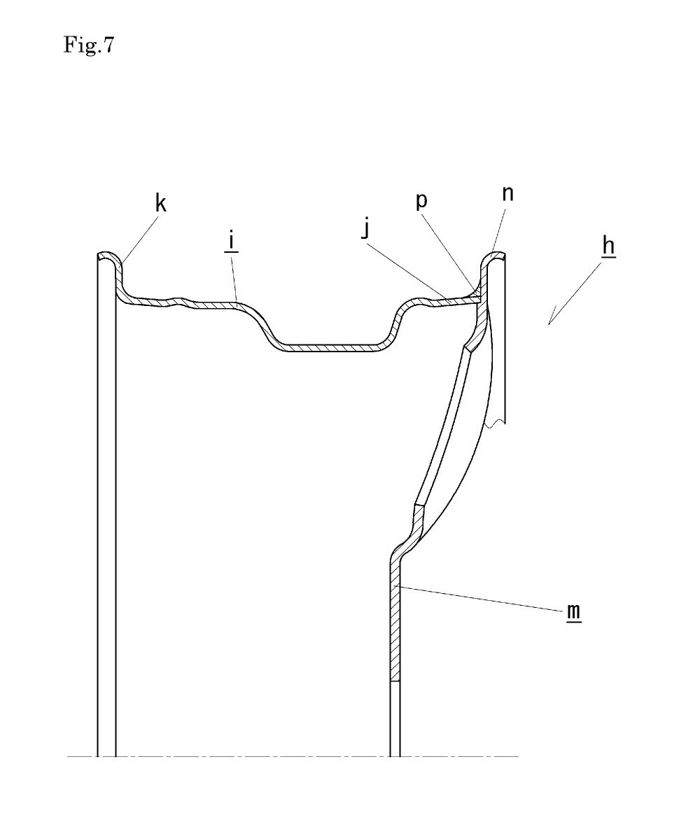

### DETAILED DESCRIPTION

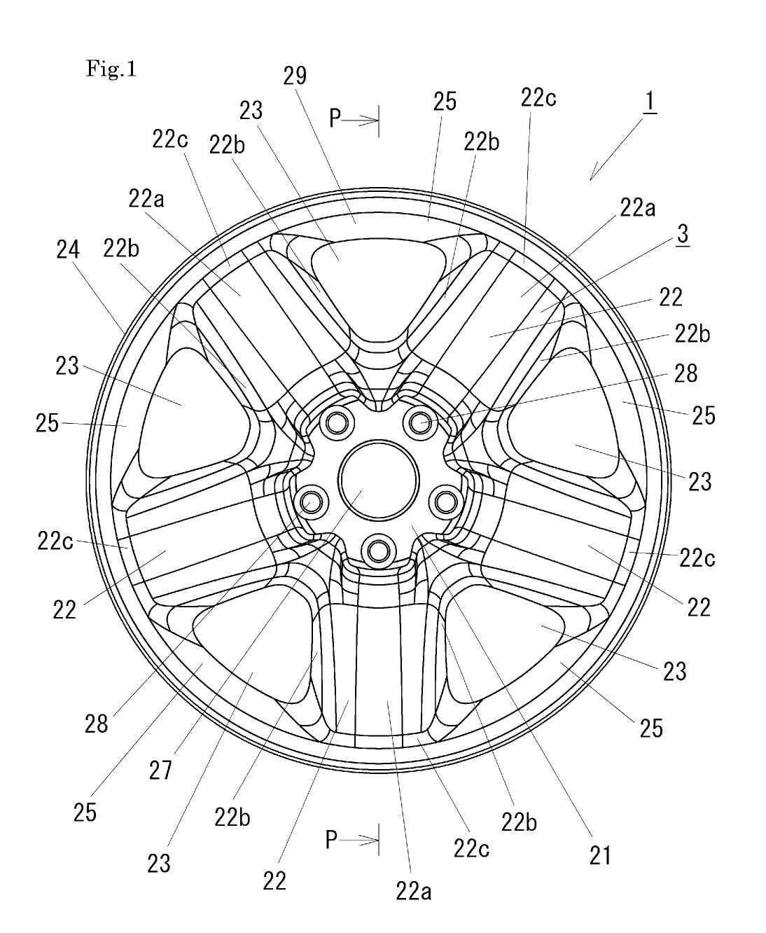

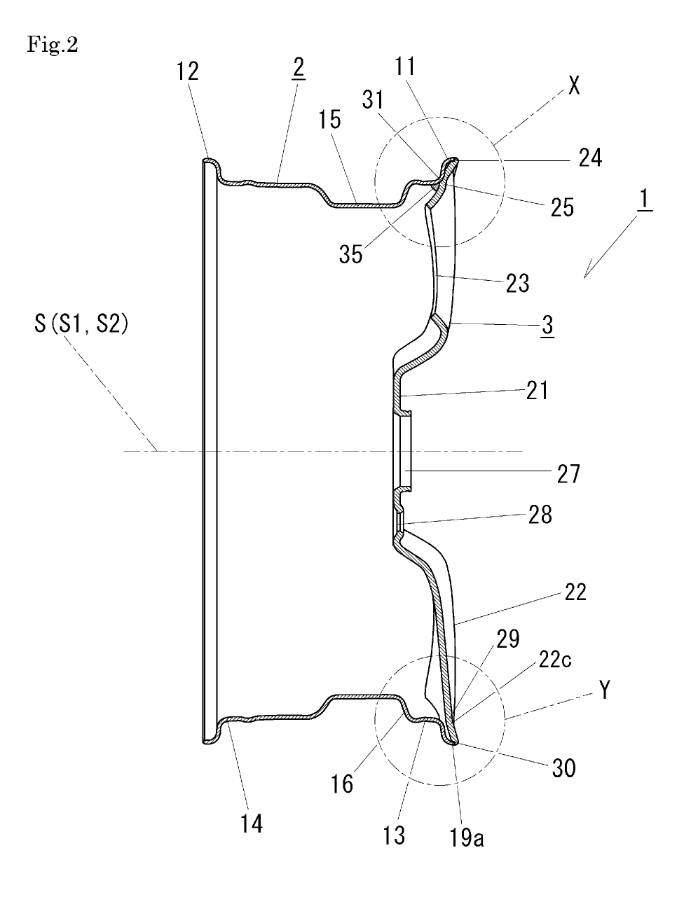

FIG. 1 is a plan view of an automotive wheel 1 according to an embodiment of the present invention. FIG. 2 is a vertical cross-sectional view of the automotive wheel 1. The automotive wheel 1 is a so-called two-piece steel wheel formed by joining a wheel rim 2 and a wheel disc 3 formed from steel plates to each other. It should be noted that in the embodiment of the present invention, a direction toward a design surface side of the wheel disc 3 from its back side is designated as a front side direction, while a direction opposite to the front side direction is designated as a back side direction. Also, the direction toward the center axis S of the automotive wheel 1 along the radial direction of the wheel is designated as a radially inward direction, and the opposite direction is designated as a radially outward direction.

The aforementioned wheel rim 2 is generally in the shape of a cylinder and includes a front and a back rim flange portions 11 and 12 provided in opening edges at ends to support a front and a back beads of a tire, and a front and a back bead seat portions 13 and 14 on which the front and back beads of the tire is seated for support and fixation are formed continuously with the rim flange portions 11 and 12. The wheel rim 2 additionally includes a well portion 15 which is provided between the front and the back bead seat portions 13 and 14, and into which the front and the back beads of the tire are to be dropped to mount the tire.

The front and the back rim flange portions 11 and 12 respectively include rising peripheral portions 17 and 18 which are continuously formed to rise from the front and the back bead seat portions 13 and 14 to the radial outsides, and curved peripheral portions 19 and 20 which extend so as to be respectively bent from the rising peripheral portions 17 and 18 to the front and the back sides and generally curved (see FIG. 2 to FIG. 6).

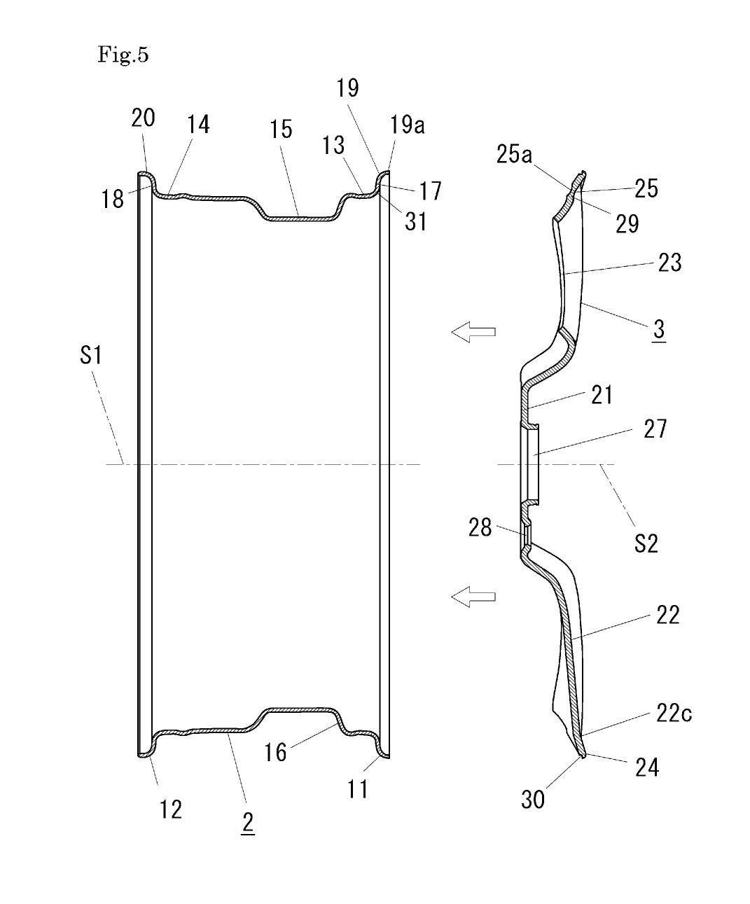

The components of the wheel rim 2 are concentrically arranged about a center axis S1 (see FIG. 2 and FIG. 5) of the wheel rim 2. The formation method of the wheel rim 2 includes forming a generally rectangular steel plate into a cylindrical shape by abutting the short sides of the plate against each other and welding the short sides to each other, then performing a rolling process in which the cylinder is pressed by specified dies from both inner and outer sides of the cylinder while it is rotated, and forming the cylinder into a perfect circle by an expanding process. Conventional formation methods can be applied to such a series of formation processes, and therefore the methods are not described herein.

Meanwhile, the aforementioned wheel disc 3 is generally in the shape of a disc and includes a hub mounting portion 21 provided at the center to be coupled to a hub of an axle, and spokes 22 extending from an outer peripheral edge of the hub mounting portion 21 to the radial outside are provided at equal intervals in a circumferential direction. Ornamental holes 23 are respectively formed between the spokes 22 adjacent to each other in the circumferential direction. A hub hole 27 is formed in the center of the hub mounting portion 21. A plurality of bolt holes 28 are formed in the radial outside of the hub hole 27 and arranged at equal intervals in the circumferential direction. The components of the wheel disc 3 are concentrically arranged about a center axis S2 (see FIG. 2 and FIG. 5) of the wheel disc 3.

The aforementioned spokes 22 are respectively formed to swell from the peripheral edge of the hub mounting portion 21 toward the front side. An outer end 22c of each spoke 22 is continuously formed with an outermost peripheral end 24 of the wheel disc 3. It should be noted that in the embodiment of the present invention, five spokes 22 are arranged at equal intervals in the circumferential direction, and five ornamental holes 23 are arranged at equal intervals in the circumferential direction.

Such a wheel disc 3 can be formed by press work of a disc-shaped steel plate, and the conventional formation methods can be applied to the formation of the wheel disc 23. Thus, the formation processes are not described herein.

A main part of the present invention is described next.

The aforementioned wheel rim 2 includes a bending peripheral portion 31 to form the front rim flange portion 11 continuously with the front bead seat portion 13 as shown in FIG. 2 to FIG. 4. That is to say, the front rim flange portion 11 bends from front end portion of the front bead seat portion 13 to a radial outside through the bending peripheral portion 31 and is curved to the front side with the curved peripheral portion 19 via the rising peripheral portion 17. An outer peripheral end 19a of the curved peripheral portion 19 is formed to generally face the front side and forms an outer peripheral end of the front rim flange portion 11.

The wheel disc 3 is formed, as shown in FIG. 1, with five spokes 22 extending radially from the hub mounting portion 21 to the radial outside, and five ornamental holes 23 in generally fan shapes provided between the adjacent spokes 22. Each of the spokes 22 includes a spoke main surface portion 22a facing the front side and side surface portions 22b and 22b formed at the sides of the spoke main surface portion 22a and slanting to the back side. The adjacent spokes 22 are continuously formed with radially inner side portions of the side surface portions 22b and 22b respectively facing to each other. It should be noted that in the embodiment of the present invention, the spoke main surface portion 22a of the spoke 22 has a recessing portion (not shown) extending from a radially inner end to a radially outer end of the poke main surface 22a (see FIG. 2).

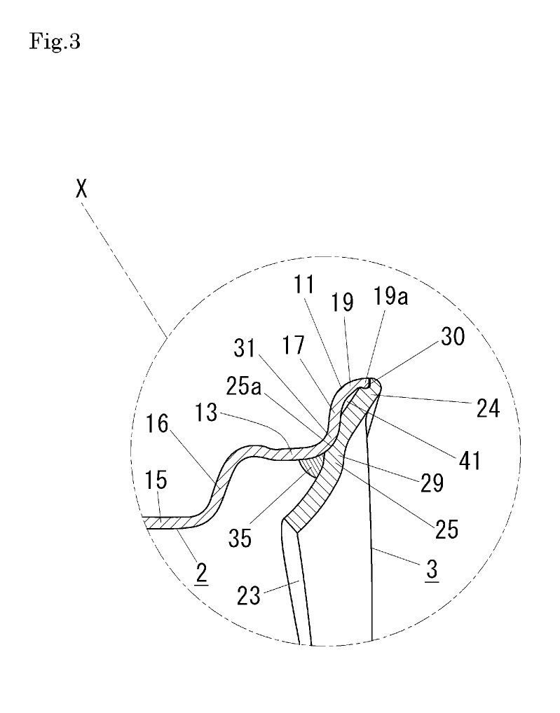

An arc-shaped hole outer edge portion 25 is formed between the outer ends 22c of the adjacent spokes 22 and along the circumference of the wheel. The hole outer edge portion 25 is formed in a shape slanting from a radial inside to the radial outside toward the front side (see FIG. 2 and FIG. 3) and continuously formed with the outermost peripheral end 24 of the wheel disc 3. In addition, the hole outer edge portion 25 is formed continuously with the side surface portions 22b and 22b of the adjacent spokes 22 facing to each other, and is formed in a shape slanting to the back side with respect to the spoke main surface portion 22a of the spoke 22.

The aforementioned ornamental hole 23 is defined by the side surface portions 22b and 22b facing to each other of the adjacent spokes 22 and the hole outer edge portion 25 between the spokes 22. The ornamental hole 23 is positioned in a back side with respect to the spoke main surface portion 22a of the spoke 22. Accordingly, the design surface is formed in a concavoconvex shape by the spoke 22 and the ornamental hole 23.

In addition, an annular section in which the aforementioned hole outer edge portion 25 and the outer end 22c of the spoke 22 are alternately formed over the circumference of the wheel is defined as an outer peripheral concavoconvex annular portion 29 according to the present invention. The outer peripheral concavoconvex annular portion 29 has an annular shape that is continuously formed in a concavoconvex shape along the circumference of the wheel. The outer peripheral concavoconvex annular portion 29 is formed concentrically with and in the same radial position as the bending peripheral portion 31 of the wheel rim 2 in a state in which the wheel disc 3 is fitted with the wheel rim 2 as described later. In other words, the radial distance to the outer peripheral concavoconvex annular portion 29 from the center axis of the wheel disc 3 is defined to be the same as the radial distance to the bending peripheral portion 31 of the wheel rim 2 from the center axis of the wheel rim 2.

On the other hand, the outermost peripheral end 24 of the wheel disc 3 includes, as shown in FIG. 2 to FIG. 5, a stepped peripheral fitting portion 30 formed in a step over the circumference of the wheel by cutting the back side of the outermost peripheral end 24 to the radial outside. The stepped peripheral fitting portion 30 is fitted with the outer peripheral end (outer peripheral end of the curved peripheral portion 19) 19a of the front rim flange portion 11 of the aforementioned wheel rim 2 and provided in a manner that the center axis of the wheel rim 2 corresponds to that of the wheel disc 3 in the fitted state. Accordingly, when the wheel rim 2 and the wheel disc 3 respectively formed through the separate processes are joined, the stepped peripheral fitting portion 30 of the wheel disc 3 is fitted with the outer peripheral end 19a of the front rim flange portion 11 of the wheel rim 2, and thus the wheel rim 2 and the wheel disc 3 can easily and stably be positioned to align the respective center axes.

The radial width of the stepped peripheral fitting portion 30 is set to be the same as or greater than the radial thickness of the outer peripheral end 19a of the front rim flange portion 11. Accordingly, with the stepped peripheral fitting portion 30 being fitted with the outer peripheral end 19a of the front rim flange portion 11, the outer peripheral end 19a is not exposed to the front side, and the boundary between the stepped peripheral fitting portion 30 and the outer peripheral end 19a is facing radially outward.

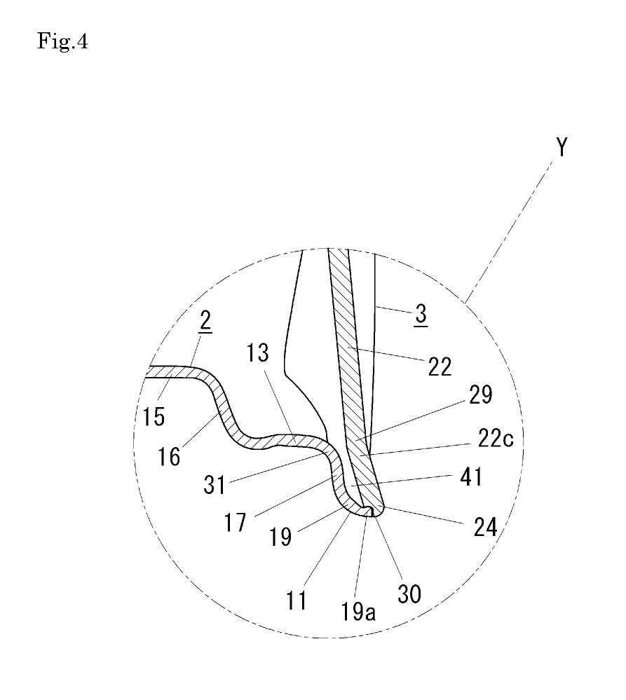

In a state in which the stepped peripheral fitting portion 30 of the outermost peripheral end 24 of the wheel disc 3 is fitted with the outer peripheral end 19a of the front rim flange portion 11 of the wheel rim 2, the bending peripheral portion 31 of the wheel rim 2 is abutted on the back surface of each of the hole outer edge portion 25 of the wheel disc 3 as shown in FIG. 3 and is not abutted on and spaced from the outer end 22c of each spoke 22 as shown in FIG. 4. This is because the spoke main surface portion 22a of the spoke 22 is formed to protrude toward the front side with respect to the hole outer edge portion 25, and the outer end 22c of the spoke 22 and the hole outer edge portion 25 are alternately formed along the circumference of the wheel.

In the embodiment of the present invention, abutting recesses 25a recessed in the back surface side of the hole outer edge portion 25 of the wheel disc 3 and having an arc shape in cross section are respectively formed in each of the hole outer edge portions 25 of the wheel disc 3 along the circumference of the wheel (see FIG. 2 to FIG. 5). The abutting recess 25a abuts against the bending peripheral portion 31 of the wheel rim 2 in a state where the outer peripheral end 19a of the front rim flange portion 11 is fitted in the stepped peripheral fitting portion 30. The abutting recess 25a is formed into the arc shape in cross section following the shape of the bending peripheral portion 31.

As described above, each hole outer edge portion 25 and the bending peripheral portion 31 are welded together from the radial inside with the outer peripheral end 19a of the front rim flange portion 11 being fitted in the stepped peripheral fitting portion 30, and a plurality of welded portions 35 are thus formed intermittently along the circumference of the wheel. Accordingly, the wheel rim 2 is integrally joined to the wheel disc 3, and the automotive wheel 1 according to the embodiment of the present invention is thus formed. The automotive wheel 1 is formed by fitting the front rim flange portion 11 of the wheel rim 2 with the outermost peripheral end 24 of the wheel disc 3 over the circumference of the wheel and welding the bending peripheral portion 31 of the wheel rim 2 and a plurality of the hole outer edge portions 25 of the wheel disc 3.

In the embodiment of the present invention, an arc-shaped abutting portion according to the present invention is formed by the hole outer edge portion 25 abutting against the bending peripheral portion 31 of the wheel rim 2. A non-abutting convex portion according to the present invention is formed by the outer end 22c of the spoke 22 spaced from the bending peripheral portion 31. An outer peripheral fitting end according to the present invention is formed by the outermost peripheral end 24 of the wheel disc 3.

In the automotive wheel 1 according to the embodiment of the present invention, the wheel disc 3 is formed with the outer peripheral concavoconvex annular portion 29 constructed with the hole outer edge portion (arc-shaped abutting portion) 25 and the outer end (non-abutting convex portion) 22c of the spoke 22, and therefore the stiffness of the wheel disc 3 in the circumferential direction and in the front and the back side directions can be improved by the shape effect of the outer peripheral concavoconvex annular portion 29.

In addition, the wheel disc 3 is formed to be fitted with the wheel rim 2 by the stepped peripheral fitting portion 30 circumferentially formed in the outermost peripheral end 24, and therefore the large design surface can be secured, and the degree of freedom in design can be improved. Accordingly, the automotive wheel 1 according to the embodiment of the present invention can have an operational advantage of the high degree of freedom in design, and at the same time provide an operational advantage of improved stiffness.

In the automotive wheel 1 according to the embodiment of the present invention, as described above, the outer peripheral end 19a of the front rim flange portion 11 of the wheel rim 2 is fitted in the stepped peripheral fitting portion 30 circumferentially formed in the outermost peripheral end 24 of the wheel disc 3, and therefore the boundary between the outer peripheral end 19a and the stepped peripheral fitting portion 30 is not exposed to the front side. Thus, the boundary is hardly visible from the front side, and the contamination produced by rust is obscured. Furthermore, there is an advantage in that, in the welding process of the wheel disc 3 and the wheel rim 2 during the manufacturing processes of the automotive wheel 1, the wheel disc 3 and the wheel rim 2 can easily and stably be positioned so that the respective center axes S1 and S2 are aligned, as the outer peripheral end 19a of the front rim flange portion 11 of the wheel rim 2 is fitted in the stepped peripheral fitting portion 30 of the wheel disc 3 (see FIG. 2 and FIG. 5).

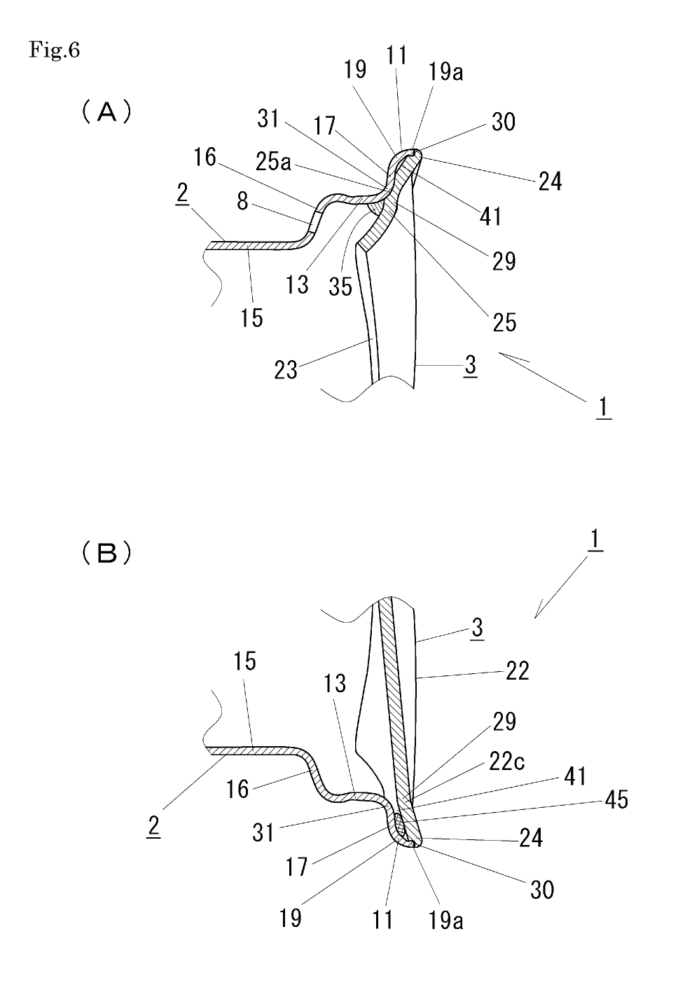

In addition, the automotive wheel 1 according to the embodiment of the present invention includes, as shown in FIG. 6, a valve hole 8 that is formed in a well wall portion 16 extending from the front bead seat portion 13 to the well portion 15 of the wheel rim 2 and where an air valve (not shown) is attached. Because the position to form the valve hole 8 is specified in advance, a weight 45 is disposed on the side opposite to the valve hole 8 with respect to the center axis S of the wheel, and thus unbalanced wheel weight caused by the weight of the air valve can be corrected.

In the embodiment of the present invention, an annular gap 41 is formed between the front rim flange portion 11 of the wheel rim 2 and the outer peripheral concavoconvex annular portion 29 of the wheel disc 3 and over the circumference of the wheel. When the aforementioned weight 45 is disposed in the annular gap 41 as shown in FIG. 6, the wheel weight balance described above can be adjusted without any influence on the design surface of the automotive wheel 1.

The aforementioned weight 45 is preferably immovable from the disposing position specified in the front rim flange portion 11 by bonding it with an adhesive or the like. In addition, the weight 45 may be fixed by welding, or the inner shape of the front rim flange portion 11 or the outer end 22c of the spoke 22 may be machined to the form in which the weight 45 does not move. The disposing position, the disposing number, the weight, etc. of the weight can be defined appropriately.

The structure of the embodiment described above includes five spokes and five ornamental holes; however, the number of the spokes and the ornamental holes may be defined appropriately. For example, the structure may include four spokes and four ornamental holes, six spokes and six ornamental holes, and the like.

The present invention is not limited to the embodiments discussed above, and may be modified appropriately within the scope and spirit of the present invention.

### DESCRIPTION OF REFERENCE NUMERALS

1: automotive wheel
2: wheel rim
3: wheel disc
11: front rim flange portion
13: front bead seat portion
17: rising peripheral portion
19: curved peripheral portion
19a: outer peripheral end (outer peripheral end of front rim flange portion)
21: hub mounting portion
22: spoke
22c: outer end (non-abutting convex portion)
23: ornamental hole
24: outermost peripheral end (outer peripheral fitting end)
25: hole outer edge portion (arc-shaped abutting portion)
29: outer peripheral concavoconvex annular portion
30: stepped peripheral fitting portion
31: bending peripheral portion
35: welded portion
41: annular gap
45: weight

1. An automotive wheel provided with a wheel rim including bead seat portions for supporting beads of a tire and rim flange portions continuously formed from the bead seat portions and bending to radial outsides, each of which is provided on a front and a back sides, and a wheel disc, and in which the wheel disc and the wheel rim are welded together,
wherein the wheel disc comprises:
an outer peripheral concavoconvex annular portion in which a plurality of arc-shaped abutting portions abutting on bending peripheral portions continuously formed from front bead seat portions to front rim flange portions of the wheel rim and formed intermittently along a circumference of the wheel, are formed along the circumference of the wheel continuously with a plurality of non-abutting convex portions formed to protrude toward the front side with respect to the arc-shaped abutting portions, spaced from the bending peripheral portion, and provided between adjacent arc-shaped abutting portions; and
an outer peripheral fitting end provided in a radial outside of the outer peripheral concavoconvex annular portion and fitted with an outer peripheral end of the front rim flange portion of the wheel rim, and
wherein welding portions in which the bending peripheral portions of the wheel rim are respectively welded to the arc-shaped abutting portions of the wheel disc are formed intermittently along the circumference of the wheel.

2. The automotive wheel according to claim 1,
wherein the wheel disc comprises:
a hub mounting portion coupled to an axle; a plurality of spokes extending radially from the hub mounting portion toward the radial outside; and a plurality of ornamental holes provided between adjacent spokes,
wherein the arc-shaped abutting portion is formed by a hole outer edge portion provided in the radial outside of each ornament hole, and the non-abutting convex portion is formed by an outer end of each spoke.

3. The automotive wheel according to claim 1,
wherein the outer peripheral fitting end of the wheel disc includes a stepped peripheral fitting portion circumferentially formed to be cut from the back side of an outermost peripheral end of the wheel disc to the radial outside, and
the stepped peripheral fitting portion is fitted with the outer peripheral end of the front rim flange portion of the wheel rim.

4. The automotive wheel according to claim 1,
wherein a weight capable of adjusting wheel weight balance is disposed at a specified position in an annular gap formed between the outer peripheral concavoconvex annular portion of the wheel disc and the front rim flange portion of the wheel rim and over the circumference of the wheel.

5. The automotive wheel according to claim 2,
wherein the outer peripheral fitting end of the wheel disc includes a stepped peripheral fitting portion circumferentially formed to be cut from the back side of an outermost peripheral end of the wheel disc to the radial outside, and
the stepped peripheral fitting portion is fitted with the outer peripheral end of the front rim flange portion of the wheel rim.

7. The automotive wheel according to claim 2,
wherein a weight capable of adjusting wheel weight balance is disposed at a specified position in an annular gap formed between the outer peripheral concavoconvex annular portion of the wheel disc and the front rim flange portion of the wheel rim and over the circumference of the wheel.

8. The automotive wheel according to claim 3,
wherein a weight capable of adjusting wheel weight balance is disposed at a specified position in an annular gap formed between the outer peripheral concavoconvex annular portion of the wheel disc and the front rim flange portion of the wheel rim and over the circumference of the wheel.
